(19) United States
(12) Patent Application Publication
(10) Pub. No.: US 2019/0285108 A1
(43) Pub. Date: Sep. 19, 2019

(54) Wall anchor

(71) Applicant: STAR PERFECT INVESTMENTS LIMITED, HONG KONG (CN)

(72) Inventor: Kwai King Cheung, Hong Kong (CN)

(21) Appl. No.: 16/427,344

(22) Filed: May 31, 2019

(30) Foreign Application Priority Data
Jun. 12, 2018 (CN) 201820904503.5

(51) Int. Cl. F16B 37/04; F16M 13/02

(52) U.S. Cl. CPC F16B 37/048; F16M 13/02

(57) ABSTRACT

A new wall anchor includes: a body, wherein the body comprises a bottom plate and two side plates which are connected with each other; wherein a screw hole is provided in the bottom plate; and a tip section provided on a front end of the body; wherein a tool palette is provided between the bottom plate and the tip end portion on the body; two side faces of the tool palette are respectively contacted with internal walls of the two side plates; a tooling hole is provided on the tool palette, wherein a central axis of the tooling hole, a longitudinal center line of the body and a longitudinal center line of the tip end portion are located on an identical straight line.

### CROSS REFERENCE OF RELATED APPLICATION

The present application claims priority under 35 U.S.C. 119(a-d) to CN 201820904503.5, filed Jun. 12, 2018.

### BACKGROUND OF THE PRESENT INVENTION

### Field of Invention

The present invention relates to a device for fixing screws, hooks, etc. on a wall, which is disposed in a wall body made of materials of board, plaster tablet or the like.

### Description of Related Arts

The wall of a civil building in countries out of China is generally made of wood or gypsum board. If a hook or a screw is needed to be installed on the wall, it is usually necessary to embed a kind of fastener in the wall body, and the fastener is a wall anchor. While installing the wall anchor, firstly drilling mounting hole in the wall with the electric drill is required, then the wall anchor body is extended into the wall through the mounting hole, and the wall anchor body is in contact with the internal wall of the wall body. At the moment, push the mounting buckle forward along the rope belt into the mounting hole, fasten the mounting buckle to the wall, and screw the screw through the center hole of the mounting buckle. The front end of the screw is combined with the screw hole on the wall anchor body to fix the screw onto the wall body, it is used to install hooks or fasten some objects to the wall. Thus, it can be seen that special tools are required during the installation process, and certain installation skills are required, and non-professionals cannot complete the installation, which has the disadvantage of inconvenient use.

### SUMMARY OF THE PRESENT INVENTION

In order to overcome the disadvantages in the conventional art, an object of the present invention is to provide a new wall anchor that can be manually installed without prior drilling.

Accordingly, in order to achieve the objects mentioned above, technical solutions adopted by the present invention are as follows. A new wall anchor comprises:

a body, wherein the body comprises a bottom plate and two side plates which are connected with each other; wherein a screw hole is provided in the bottom plate; and

a tip section provided on a front end of the body;

wherein a tool palette is provided between the bottom plate and the tip end portion on the body; two side faces of the tool palette are respectively contacted with internal walls of the two side plates; a tooling hole is provided on the tool palette, wherein a central axis of the tooling hole, a longitudinal center line of the body and a longitudinal center line of the tip end portion are located on an identical straight line. An end of the body which is firstly contacted with the wall is defined as a front end. A predetermined mounting position of the wall is quickly positioned in by the positioning tip on the tip end section by a customer. After positioning, by combining a front end of a mounting tool such as a manual or electric screwdriver, with the tool hole on the tool board, the mounting tool is strongly rotated with force. The blades on the two side tips of the tip portion facilitate rapid drilling because the tool palette is located between the screw hole and the tip end section, and the tool palette is located between the screw hole and the tip end section, and behind the tip end section. The central axis of the tooling hole, the longitudinal center line of the body, the longitudinal center line of the tip end portion are located on the identical straight line. Rotating the mounting tool is capable of forcing the body to stably enter the wall without deviating from a center of the installation position. The fixing strap is provided on the internal wall of the body, and the fixing strap is mounted with the mounting buckle. After the body enters the wall body, one end of the body is suspended by gravity, so that the body is in contact with the internal wall of the wall, and at the moment, the buckle is pushed forward along fixing strap into the mounting hole drilled by the tip end section, fixes the mounting buckle to the wall, and screws a screw through a center hole of the mounting buckle, and the screw passes through the fixing strap located in the wall to connect the center hole on the body, in such a manner that the body is fixed on the wall. A hook and other objects may be fixed to the wall by the screw, just by breaking and removing the fixing strap on an external of the wall.

In order to fix the tool palette, two fixing blocks for fixing two sides of the tool palette are respectively provided on each of the two side plates.

In order to quickly locate and drill a mounting hole, the tip end portion comprises a positioning tip and two side tips provided on both sides of the positioning tip, two blades are respectively provided on the two side tips; front ends of the positioning tip protrude from front ends of the two side tips.

A strip hole is provided on the bottom plate; two circular holes are respectively provided on the two side plates.

The two side tips are respectively disposed at front ends of the two side plates and the side tips are integrally molded with the side plates; the positioning tips are located at a front end of the bottom plate.

The bottom plate is integrally molded with the two side plates, and the tip end portion is integrally molded with the body.

Beneficial effects of the present invention are as follows. A predetermined mounting position of the wall is quickly positioned in by the positioning tip on the tip end section by a customer. After positioning, by combining a front end of a mounting tool such as a manual or electric screwdriver, with the tool hole on the tool board, the mounting tool is strongly rotated with force. The blades on the two side tips of the tip portion facilitate rapid drilling because the tool palette is located between the screw hole and the tip end section, and the tool palette is located between the screw hole and the tip end section, and behind the tip end section. The central axis of the tooling hole, the longitudinal center line of the body, the longitudinal center line of the tip end portion are located on the identical straight line. Rotating the mounting tool is capable of forcing the body to stably enter the wall without deviating from a center of the installation position. The fixing strap is provided on the internal wall of the body, and the fixing strap is mounted with the mounting buckle. After the body enters the wall body, one end of the body is suspended by gravity, so that the body is in contact with the internal wall of the wall, and at the moment, the buckle is pushed forward along fixing strap into the mounting hole drilled by the tip end section, fixes the mounting buckle to the wall, and screws a screw through a center hole of the mounting buckle, and the screw 8 passes through the fixing strap located in the wall to connect the center hole on the body, in such a manner that the body is fixed on the wall.

### BRIEF DESCRIPTION OF THE DRAWINGS

FIG. 1 is a first schematic stereogram according to a preferred embodiment of the present invention.

FIG. 2 is a second schematic stereogram according to the preferred embodiment of the present invention.

FIG. 3 is a third schematic stereogram according to the preferred embodiment of the present invention.

FIG. 4 is a fourth schematic stereogram according to the preferred embodiment of the present invention.

FIG. 5 is a first schematic view of a body of the present invention connected to a fixing strap.

FIG. 6 is a second schematic view of the body of the present invention connected to the fixing strap.

FIG. 7 is a first installation schematic view of the present invention;

FIG. 8 is a second installation schematic view of the present invention;

FIG. 9 is a third installation schematic view of the present invention.

### DETAILED DESCRIPTION OF THE PREFERRED EMBODIMENT

In order to make the present invention to be better understood by the skills in the art, further descriptions of the present invention is illustrated combining with the accompanying drawing and the preferred embodiments of the present invention.

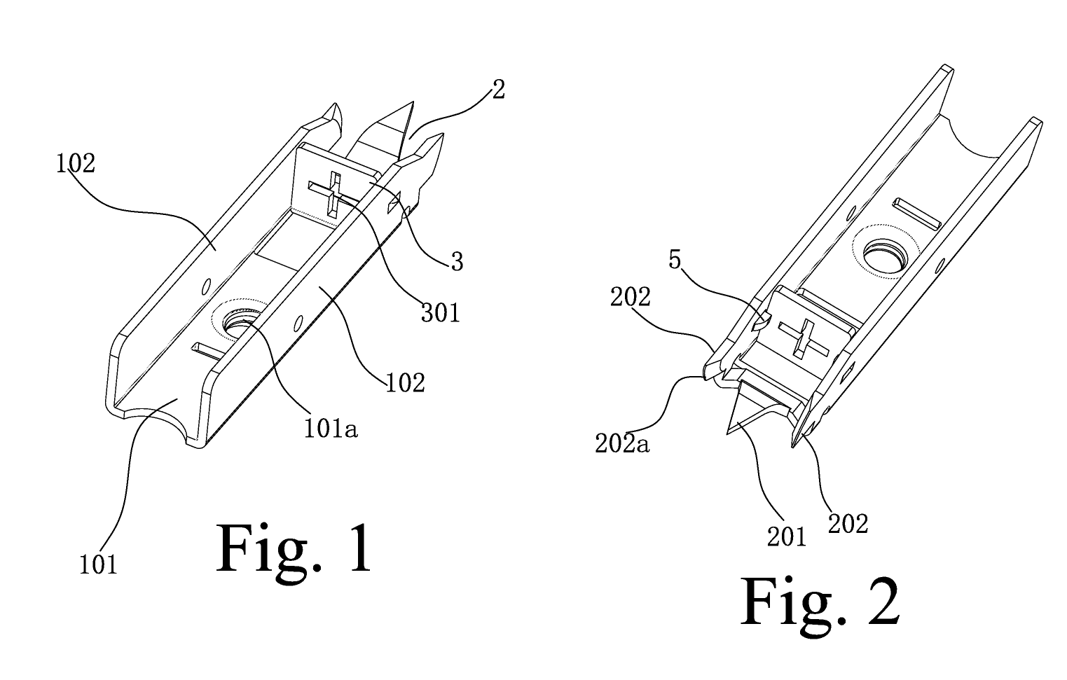

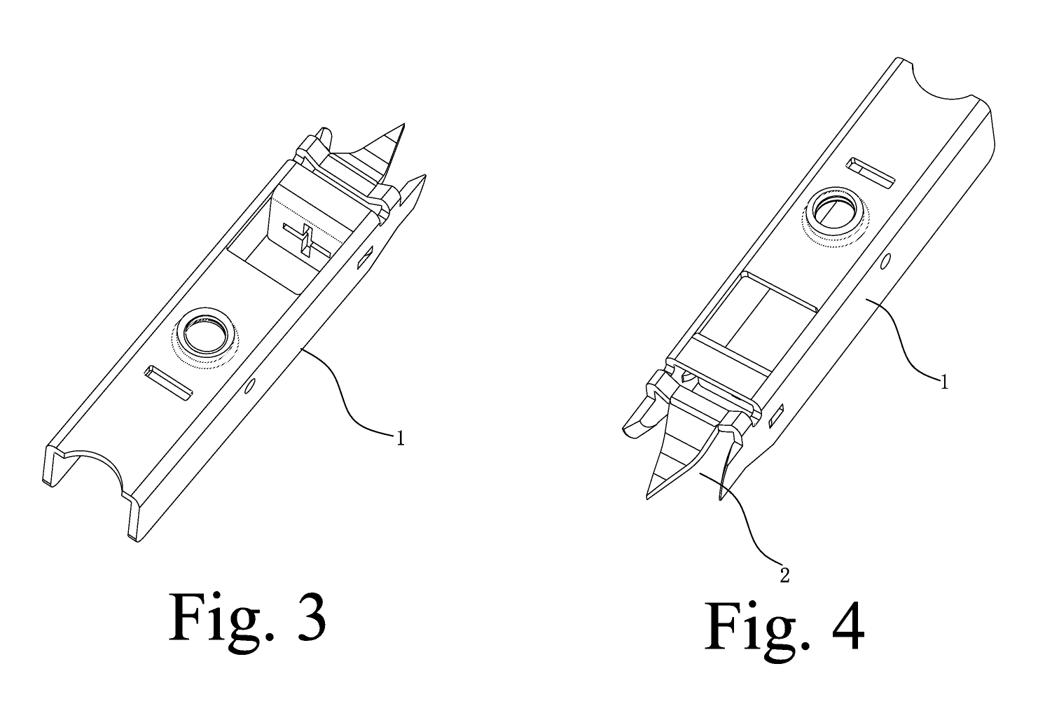

As shown in FIGS. 1-4, a wall anchor comprises:

a body 1, wherein the body 1 comprises a bottom plate 101 and two side plates 102 which are connected with each other; wherein a screw hole 101a is provided in the bottom plate 101a; and

a tip section 2 provided on a front end of the body 1;

wherein a tool palette 3 is provided between the bottom plate 101a and the tip end portion 2 on the body 1; two side faces of the tool palette 3 are respectively contacted with internal walls of the two side plates 102; a tooling hole 301 is provided on the tool palette 3, wherein a central axis of the tooling hole 301, a longitudinal center line of the body 1 and a longitudinal center line of the tip end portion 2 are located on an identical straight line.

The tooling hole 301 is in a cross shape or a plum shape, and can of course be in a linear shape or other shapes for matching with different types of manual/electric screwdrivers. In order to fix the tool palette 3, two fixing blocks 5 for fixing two sides of the tool palette 3 are respectively provided on each of the two side plates 102.

In order to quickly locate and drill a mounting hole, the tip end portion 2 comprises a positioning tip 201 and two side tips 202 provided on both sides of the positioning tip 201, two blades 202a are respectively provided on the two side tips 202; front ends of the positioning tip protrude from front ends of the two side tips 202, i.e., the positioning tips 201 have a greater length than the two side tips for easy positioning, and the side tips 202 are used for rapidly cutting a wall.

A longitudinal centerline of the positioning tip 201 is on an identical line with the central axis of the tooling hole 301 and the longitudinal centerline of the body 1.

The two side tips 202 are respectively disposed at the front ends of the two side plates 102 and the side tips 202 are integrally molded with the side plates; the positioning tips are located at the front end of the bottom plate.

The bottom plate 101 is integrally molded with the two side plates 102, and the tip end portion 2 is integrally molded with the body 1.

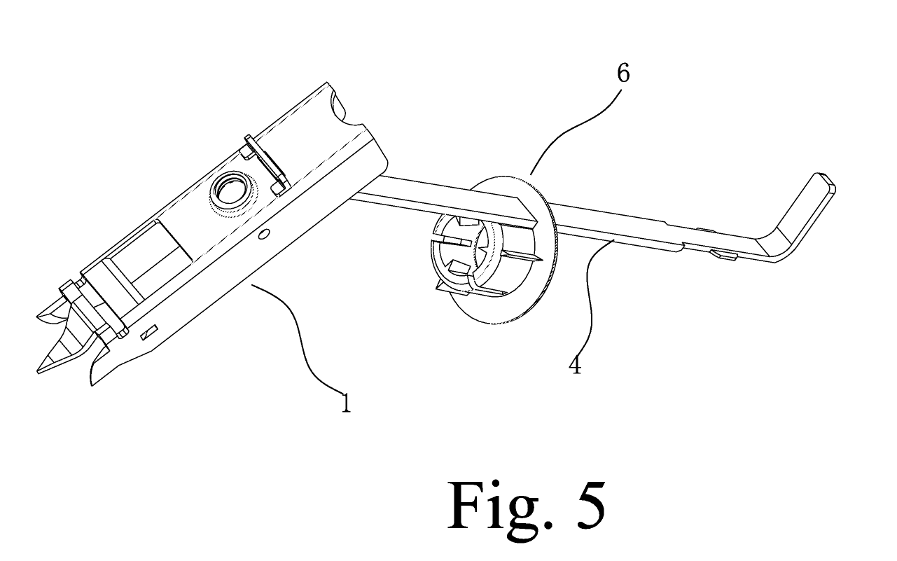

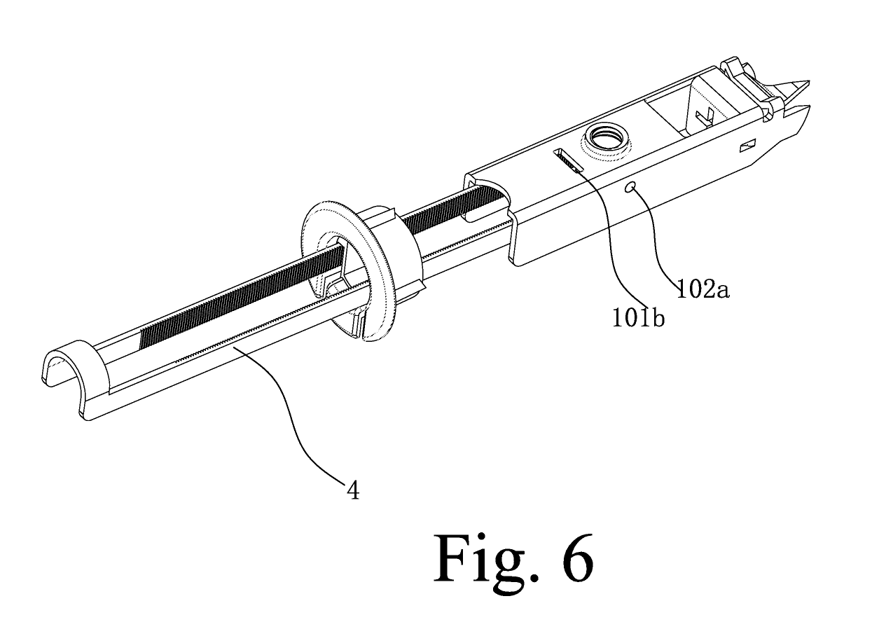

In order to facilitate installation, a fixing strap 4 is further provided on an internal wall of the body, and a mounting buckle 6 is provided on the fixing strap 4. The fixing strap 4 is made of a plastic material and can be embodied as a monorail structure. As shown in FIGS. 5 and 6, corresponding to the fixing strap 4 in the monorail structure, a strip hole 101b for fixing the fixing strap 4 is provided on the bottom plate 101; the fixing strap 4 may also be a double rail structure, as shown in FIG. 6, corresponding to the fixing strap 4 in the double rail structure, two circular holes 102a for fixing the fixing strap 4 are respectively provided on the two side plates 102.

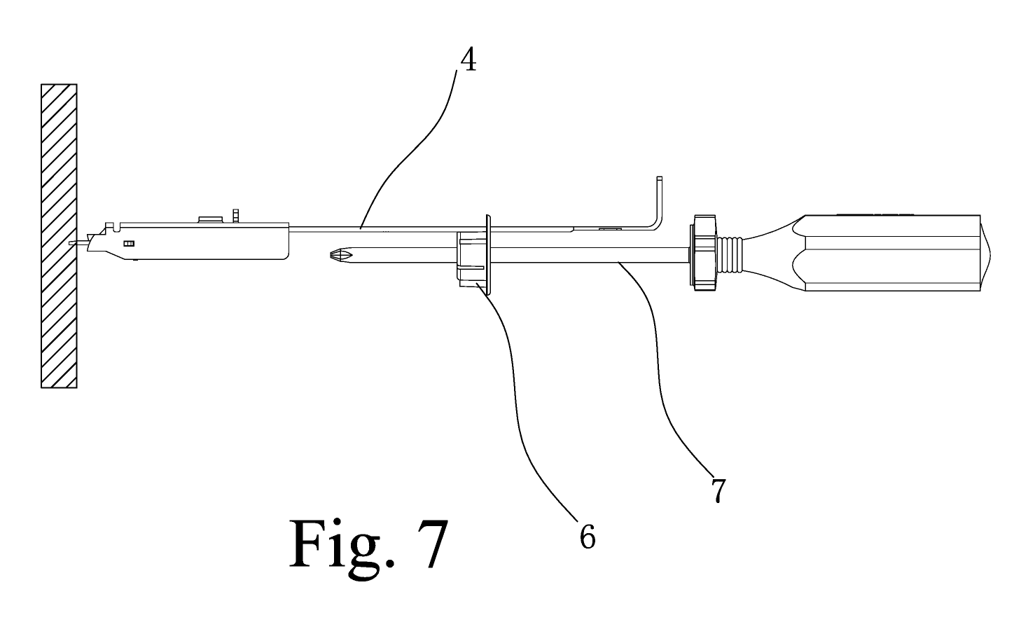

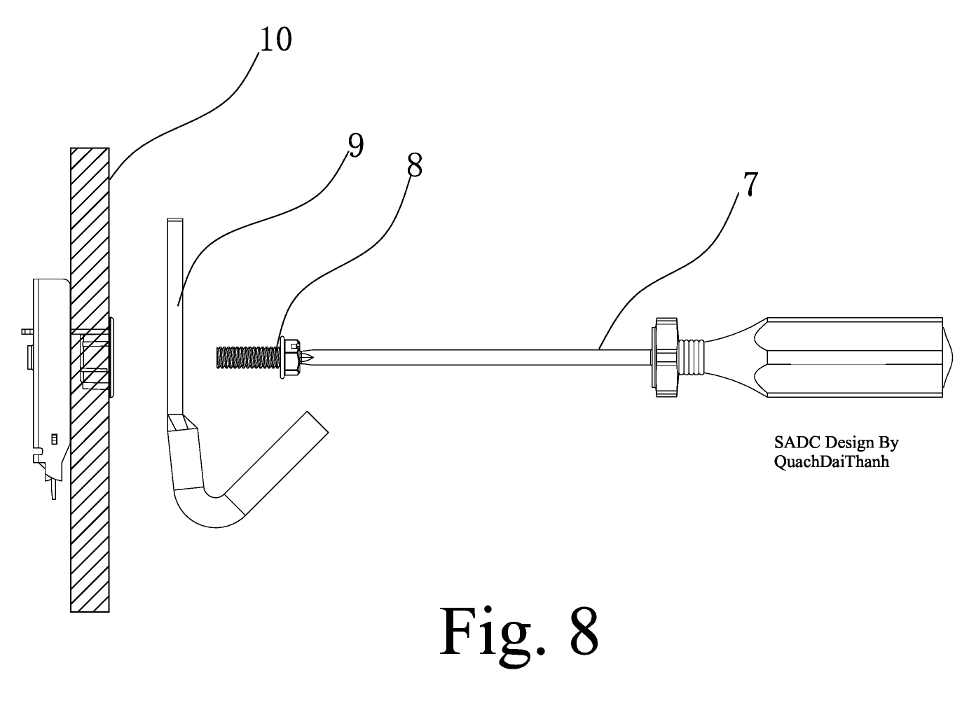

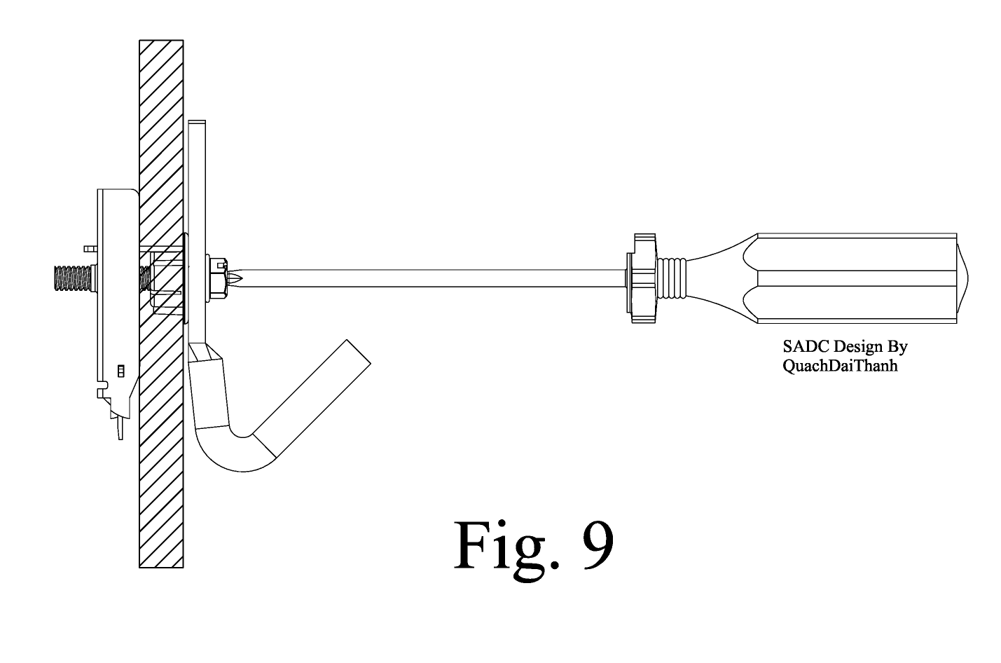

As shown in FIGS. 7-8, a predetermined mounting position of the wall is quickly positioned in by the positioning tip 201 on the tip end section 2 by a customer. After positioning, by combining a front end of a mounting tool 7 such as a manual or electric screwdriver, with the tool hole on the tool board, the mounting tool 7 is strongly rotated with force. The blades on the two side tips 202 of the tip portion facilitate rapid drilling because the tool palette 3 is located between the screw hole 101a and the tip end section 2, and the tool palette 3 is located between the screw hole 101a and the tip end section 2, and behind the tip end section 2. The central axis of the tooling hole 301, the longitudinal center line of the body 1, the longitudinal center line of the tip end portion 2 are located on the identical straight line. Rotating the mounting tool 7 is capable of forcing the body to stably enter the wall without deviating from a center of the installation position. The fixing strap 4 is provided on the internal wall of the body, and the fixing strap 4 is mounted with the mounting buckle 6. After the body enters the wall body, one end of the body is suspended by gravity, so that the body 1 is in contact with the internal wall of the wall, and at the moment, the buckle 6 is pushed forward along fixing strap 4 into the mounting hole drilled by the tip end section 2, fixes the mounting buckle 6 to the wall 10, and screws a screw 8 through a center hole of the mounting buckle, and the screw 8 passes through the fixing strap located in the wall to connect the center hole 101a on the body, in such a manner that the body 1 is fixed on the wall.

A hook 9 and other objects may be fixed to the wall by the screw 8, just by breaking and removing the fixing strap on an external of the wall. Compared with the conventional art, the present invention does not need to drill the installation hole in advance, so no professional operation is required, and the consumer can complete installation by using a simple tool, which is convenient to use and is beneficial to save installation cost.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A new wall anchor comprising:
a body, wherein the body comprises a bottom plate and two side plates which are connected with each other; wherein a screw hole is provided in the bottom plate; and
a tip section provided on a front end of the body;
wherein a tool palette is provided between the bottom plate and the tip end portion on the body; two side faces of the tool palette are respectively contacted with internal walls of the two side plates; a tooling hole is provided on the tool palette, wherein a central axis of the tooling hole, a longitudinal center line of the body and a longitudinal center line of the tip end portion are located on an identical straight line.

2. The new wall anchor, as recited in claim 1, wherein two fixing blocks for fixing two sides of the tool palette are respectively provided on each of the two side plates.

3. The new wall anchor, as recited in claim 1, wherein the tip end portion comprises a positioning tip and two side tips provided on both sides of the positioning tip, two blades are respectively provided on front ends of the two side tips; front ends of the positioning tip protrude from the front ends of the two side tips.

4. The new wall anchor, as recited in claim 1, wherein a strip hole is provided on the bottom plate; two circular holes are respectively provided on the two side plates.

5. The new wall anchor, as recited in claim 3, wherein the two side tips are respectively disposed at front ends of the two side plates and the side tips are integrally molded with the side plates; the positioning tips are located at a front end of the bottom plate.

6. The new wall anchor, as recited in claim 1, wherein the bottom plate is integrally molded with the two side plates, and the tip end portion is integrally molded with the body.
